(19) United States
(12) Patent Application Publication
(10) Pub. No.: US 2026/0208416 A1
(43) Pub. Date: Jul. 23, 2026

(54) PLASTICIZING DEVICE, INJECTION MOLDING DEVICE, AND SCREW

(71) Applicant: SEIKO EPSON CORPORATION, Tokyo (JP)

(72) Inventor: Riona TODA, SHIOJIRI-SHI (JP)

(73) Assignee: SEIKO EPSON CORPORATION, Tokyo (JP)

(21) Appl. No.: 19/452,896

(22) Filed: Jan. 20, 2026

(30) Foreign Application Priority Data
Jan. 22, 2025 (JP) 2025-008989

(51) Int. Cl. B29C 45/47; B29C 45/60

(52) U.S. Cl. CPC B29C 45/47; B29C 45/60

(57) ABSTRACT

A plasticizing device including a rotating screw, a barrel positioned to face the screw and having a communication hole through which plasticized material flows out to the outside, and a first heating section configured to heat material is provided. The screw includes a first screw section that has a facing surface which oppose the barrel and a second screw section protruding from the facing surface in a direction of a rotation axis of the first screw section. A tip end of the second screw section is located in the communication hole, and the second screw section is located to overlap the rotation axis. In the rotation axis direction, a distance between the tip end of the second screw section and the facing surface of the first screw section is larger than a width of the second screw section.

The present application is based on, and claims priority from JP Application Serial Number 2025-008989, filed January 22, 2025, the disclosure of which is hereby incorporated by reference herein in its entirety.

### BACKGROUND

### 1. Technical Field

The present disclosure relates to a plasticizing device, an injection molding device, and a screw.

### 2. Related Art

An injection molding device is known that molds a molded article by injecting a material plasticized by a plasticizing device toward a cavity of a molding die and curing the material.

For example, JP-A-2023-158737 discloses a plasticizing device including a drive motor, a flat screw that has a groove forming surface in which a groove is formed and that rotates around a shaft of the drive motor, a barrel that has a facing surface opposing the groove forming surface and that has a communication hole through which a plasticized material flows out to the outside, and a heating section that heats the material supplied to the groove.

There is a demand for the plasticizing amount of the material per unit time to be improved in the plasticizing device as described above.

### SUMMARY

A plasticizing device according to an aspect of the present disclosure is

a plasticizing device that includes

a drive motor;

a screw rotated by the drive motor;

a barrel positioned to face the screw and having a communication hole through which plasticized material flows out to the outside; and

a first heating section configured to heat material, wherein

the screw includes

a first screw section that has a facing surface which oppose the barrel and

a second screw section protruding from the facing surface in a direction of a rotation axis of the first screw section, a tip end of the second screw section being located in the communication hole,

the second screw section is located to overlap the rotation axis,

in the rotation axis direction, a distance between the tip end of the second screw section and the facing surface of the first screw section is larger than a width of the second screw section.

a first groove to which the material is supplied is formed in the facing surface of the first screw section,

a second groove connected to the first groove is formed on a side surface of the second screw section, and

An aspect of an injection molding device according to the present disclosure is

an injection molding device that includes

the plasticizing device;

a nozzle that injects the material plasticized by the plasticizing device; and

a mold opening and closing device that opens and closes a molding die having a cavity to which the injected material is supplied.

A screw according to an aspect of the present disclosure is

a screw provided in plasticizing device having communication hole through which a plasticized material flows out to the outside, the screw including

a first screw section that has a facing surface opposing the barrel and

a second screw section that protrudes from the facing surface in a direction of a rotation axis of the first screw section and that has a tip end located in the communication hole, wherein

the second screw section is located to overlap the rotation axis,

a first groove to which the material is supplied is formed in the facing surface of the first screw section,

a second groove connected to the first groove is formed on a side surface of the second screw section, and

in the rotation axis direction, a distance between the tip end of the second screw section and the facing surface of the first screw section is larger than a width of the second screw section.

### BRIEF DESCRIPTION OF THE DRAWINGS

FIG. 1 is a side view schematically illustrating an injection molding device according to the present embodiment.

FIG. 2 is a cross-sectional view schematically illustrating the injection molding device according to the present embodiment.

FIG. 3 is a view schematically illustrating a barrel of the injection molding device according to the present embodiment.

FIG. 4 is a perspective view schematically illustrating a screw of the injection molding device according to the present embodiment.

FIG. 5 is a perspective view schematically illustrating the screw of the injection molding device according to the present embodiment.

FIG. 6 is a perspective view schematically illustrating the screw of the injection molding device according to the present embodiment.

FIG. 7 is a perspective view schematically illustrating the screw of the injection molding device according to the present embodiment.

FIG. 8 is a perspective view schematically illustrating the screw of the injection molding device according to the present embodiment.

FIG. 9 is a perspective view schematically illustrating a first groove and a second groove of the injection molding device according to the present embodiment.

FIG. 10 is a side view schematically illustrating a second screw section of an injection molding device according to a first modification of the present embodiment.

FIG. 11 is a cross-sectional view schematically illustrating the second screw section of the injection molding device according to the first modification of the present embodiment.

FIG. 12 is a perspective view schematically illustrating first grooves and second grooves of the injection molding device according to the first modification of the present embodiment.

FIG. 13 is a cross-sectional view schematically illustrating a three dimensional molding device according to the present embodiment.

### DESCRIPTION OF EMBODIMENTS

Hereinafter, preferred embodiments of the present disclosure will be described in detail with reference to the drawings. It should be noted that the embodiments described below do not unduly limit the content of the present disclosure described in the appended claims. All of the configurations described below are not necessarily essential constituent elements of the present disclosure.

### 1. Injection molding device

### 1.1. Overall configuration

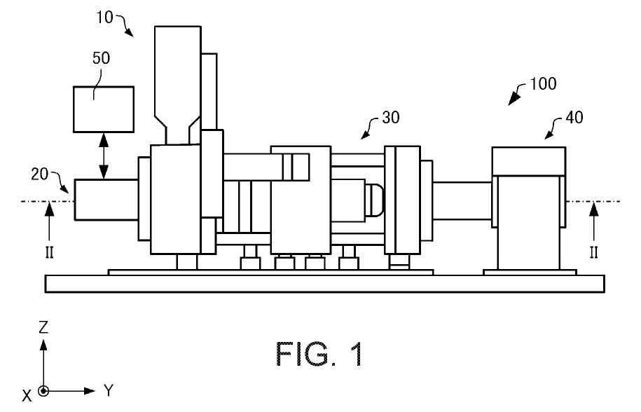

First, an injection molding device according to the present embodiment will be described with reference to the drawings. FIG. 1 is a side view schematically illustrating an injection molding device 100 according to the present embodiment. It should be noted that, in FIG. 1, an X-axis, a Y-axis, and a Z-axis are illustrated as three axes orthogonal to one another. The X-axis direction and the Y-axis direction are, for example, horizontal directions. The Z-axis direction is, for example, a vertical direction.

As illustrated in FIG. 1, the injection molding device 100 includes, for example, a material supply section 10, an injection section 20, a mold section 30, a molding die clamping section 40, and a control section 50

The material supply section 10 supplies a material that serves as a raw material to the injection section 20. The material supply section 10 may be configured by a hopper. The material supplied from the material supply section 10 has, for example, a pellet form. The material supplied from the material supply section 10 is, for example, acrylonitrile butadiene styrene (ABS) resin.

The injection section 20 plasticizes the material supplied from the material supply section 10 to form a plasticization material. The injection section 20 injects the plasticization material toward the mold section 30.

It should be noted that the term “plasticization" is a concept including melting, and means changing from a solid to a state having fluidity. Specifically, in the case of a material that undergoes glass transition, the plasticization means that the temperature of the material is set to a temperature equal to or higher than the glass transition point. In the case of a material that does not undergo glass transition, plasticization means that the temperature of the material is raised to the melting point or higher.

A cavity corresponding to the shape of the molded article is formed in the mold section 30. The plasticization material injected from the injection section 20 flows into the cavity. The plasticization material is cooled and solidified to produce a molded article.

The molding die clamping section 40 opens and closes the mold section 30. The molding die clamping section 40 opens the mold section 30 after the plasticization material is cooled and solidified. By this, the molded article is discharged to the outside.

The control section 50 is configured by, for example, a computer including a processor, a main storage device, and an input and output interface that inputs and outputs signals to and from the outside. The control section 50 performs various functions by, for example, the processor executing a program read into the main storage device. Specifically, the control section 50 controls the injection section 20 and the molding die clamping section 40. It should be noted that the control section 50 may be configured by a combination of a plurality of circuits instead of a computer.

### 1.2. Specific configuration

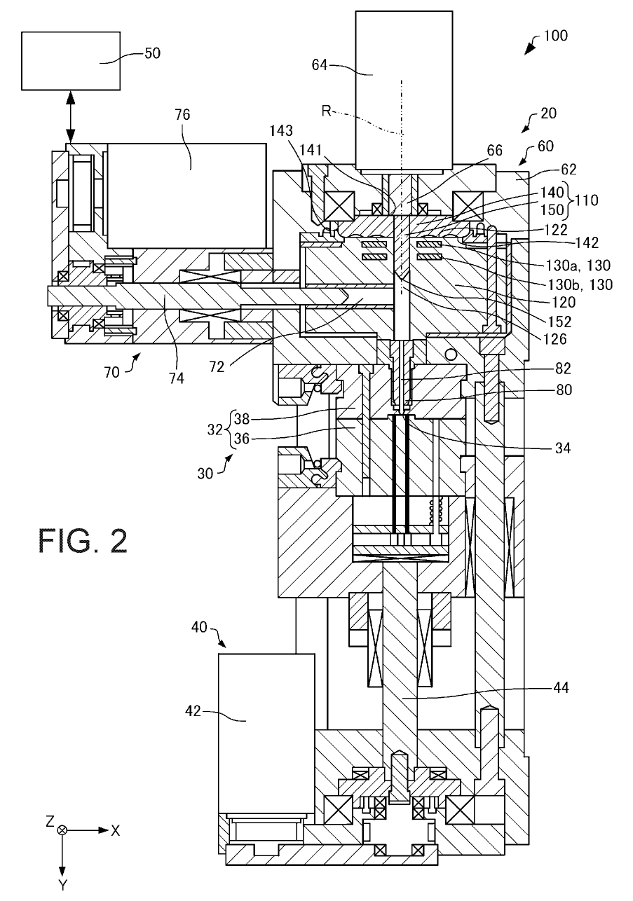

FIG. 2 is a cross-sectional view taken along line II-II of FIG. 1, schematically illustrating the injection molding device 100. As illustrated in FIG. 2, the injection section 20 includes, for example, a plasticizing device 60, an injection mechanism 70, and a nozzle 80.

The plasticizing device 60 is configured to plasticize at least a part of the material supplied from the material supply section 10, generate a pasty plasticization material having fluidity, and guide the plasticization material to the injection mechanism 70. The plasticizing device 60 includes, for example, a screw case 62, a drive motor 64, a screw 110, a barrel 120, and heating sections 130.

The screw case 62 is a housing that accommodates the screw 110. The screw 110 is accommodated in a space surrounded by the screw case 62 and the barrel 120.

The drive motor 64 is provided outside the screw case 62. The drive motor 64 is configured to include, for example, a servo motor. A shaft 66 of the drive motor 64 is connected to a shaft face 141 of the screw 110. The drive motor 64 is controlled by the control section 50. It should be noted that, although not illustrated, the shaft 66 of the drive motor 64 and the shaft face 141 of the screw 110 may be connected to each other via a decelerator.

The screw 110 is connected to the drive motor 64. The screw 110 is rotated by the torque generated by the drive motor 64. The screw 110 is provided in the plasticizing device 60. The screw 110 will be described in detail later.

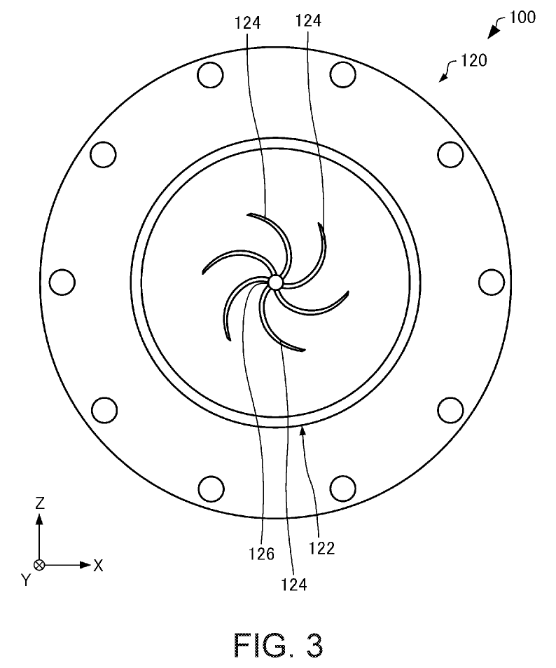

The barrel 120 is provided on the +Y-axis direction side of the screw 110. The barrel 120 is located opposite the screw 110. The barrel 120 has a facing surface 122 that opposes the screw 110. Here, FIG. 3 is a view schematically illustrating the barrel 120.

As illustrated in FIG. 3, barrel grooves 124 and a communication hole 126 are formed in the facing surface 122 of the barrel 120. A plurality of barrel grooves 124 are formed. In the illustrated example, six barrel grooves 124 are formed, but the number of barrel grooves 124 is not particularly limited. The plurality of barrel grooves 124, when viewed from the Y-axis direction, are formed around the communication hole 126. The barrel grooves 124 have one end connected to the communication hole 126 and extend in a spiral shape from the communication hole 126 toward the outer periphery of the barrel 120. The barrel grooves 124 have a function of guiding the plasticization material to the communication hole 126. The communication hole 126 is formed, for example, at the center of the facing surface 122. The communication hole 126 extends in the Y-axis direction. The communication hole 126 penetrates the barrel 120. The communication hole 126 allows the plasticized material to flow out to the outside.

It should be noted that the shape of the barrel grooves 124 are not particularly limited, and may be, for example, a linear shape. The barrel grooves 124 may not be connected to the communication hole 126 at one end. The barrel grooves 124 may not be formed in the facing surface 122. However, in consideration of efficiently guiding the plasticized material to the communication hole 126, the barrel grooves 124 are desirably formed in the facing surface 122.

As illustrated in FIG. 2, the heating sections 130 are provided in the barrel 120. The heating sections 130 are heaters. The heating sections 130 are, for example, rod heaters. The heating sections 130 heat the material supplied between the screw 110 and the barrel 120. The output of the heating sections 130 is controlled by the control section 50. The plasticizing device 60 heats the material while transporting the material toward the communication hole 126 by the screw 110, the barrel 120, and the heating sections 130, and generates a plasticization material. The plasticizing device 60 causes the generated plasticization material to flow out from the communication hole 126.

The heating sections 130 are provided, for example, on the -Y-axis direction side of a cylinder 72 of the injection mechanism 70. A plurality of heating sections 130, for example, are provided. The first heating sections 130a and the second heating sections 130b of the plurality of heating sections 130 are arranged in the Y-axis direction. The first heating sections 130a and the second heating sections 130b are separated from each other. The number of heating sections 130 is not particularly limited. Although not illustrated, three or more heating sections 130 may be provided.

It should be noted that, although not illustrated, the shape of the heating sections 130 may be a ring shape when viewed from the Y-axis direction. A third heating section of the plurality of heating sections 130 may be provided at a position on the -Y-axis direction side of the cylinder 72. The heating sections 130 may not be provided in the barrel 120, for example, and may be provided in the screw 110.

The injection mechanism 70 includes, for example, a cylinder 72, a plunger 74, and a plunger drive section 76. The cylinder 72 is a substantially cylindrical member connected to the communication hole 126.The plunger 74 moves inside the cylinder 72. The plunger 74 is driven by a plunger drive section 76 including a motor, a gear, and the like. The plunger drive section 76 is controlled by the control section 50. It should be noted that, although not illustrated, the cylinder 72 may be connected to a flow path downstream of the communication hole 126.

The injection mechanism 70 performs metering and injection operations by the plunger 74 sliding inside the cylinder 72. Metering operation refers to an operation in which the plunger 74 is moved in the -X-axis direction away from the communication hole 126, thereby guiding the plasticization material located in the communication hole 126 into the cylinder 72 and measuring it in the cylinder 72. Injection operation refers to an operation in which the plunger 74 is moved in the +X-axis direction approaching the communication hole 126, thereby injecting the plasticization material in the cylinder 72 into the mold section 30 via the nozzle 80.

The nozzle 80 has a nozzle aperture 82 communicating with the communication hole 126. The nozzle 80 injects the plasticization material that was plasticized by the plasticizing device 60 into a molding die 32 of the mold section 30. Specifically, by executing the above-described metering operation and injection operation, the plasticization material measured in the cylinder 72 is sent from the injection mechanism 70 to the nozzle aperture 82 via the communication hole 126. The plasticization material is injected from the nozzle aperture 82 into the mold section 30.

The mold section 30 has the molding die 32. The plasticization material injected from the nozzle 80 is supplied to the cavity 34 of the molding die 32. Specifically, the molding die 32 includes a movable molding die 36 and a fixed molding die 38 facing each other, and includes the cavity 34 between the movable molding die 36 and the fixed molding die 38. The cavity 34 is a space corresponding to the shape of the molded article. The movable molding die 36 and the fixed molding die 38 are made of metal. It should be noted that the movable molding die 36 and the fixed molding die 38 may be made of ceramic or resin.

The molding die clamping section 40 includes, for example, a molding die drive section 42 and a ball screw section 44. The molding die drive section 42 is configured by, for example, a motor, a gear, and the like. The molding die drive section 42 is connected to the movable molding die 36 via a ball screw section 44. The molding die drive section 42 is controlled by the control section 50. The ball screw section 44 transmits power generated by drive of the molding die drive section 42 to the movable molding die 36. The molding die clamping section 40 is a mold opening and closing device that opens and closes the mold section 30 by moving the movable molding die 36 by the molding die drive section 42 and the ball screw section 44.

### 1.3. Screw

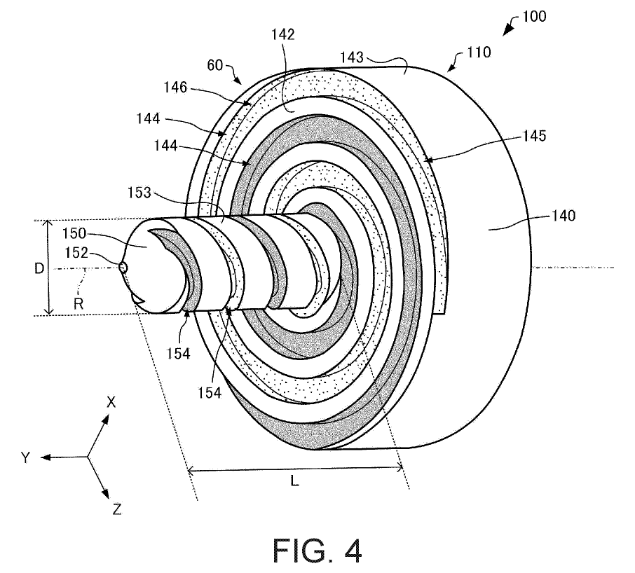

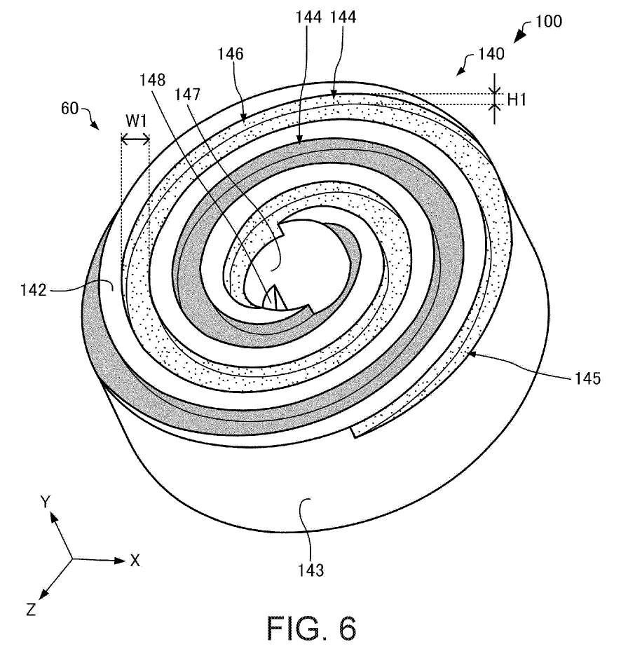

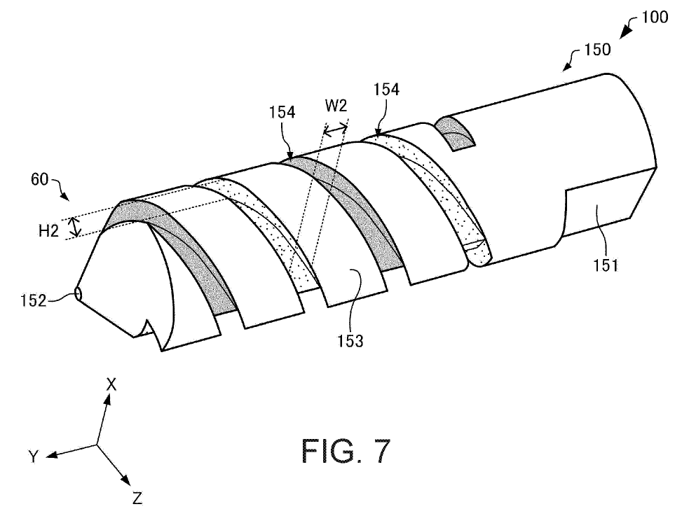

FIGS. 4 to 8 are perspective views schematically illustrating the screw 110. As illustrated in FIGS. 4 to 8, the screw 110 includes a first screw section 140 and a second screw section 150. It should be noted that, for convenience, the second screw section 150 is not illustrated in FIG. 6. In FIG. 7, the first screw section 140 is not illustrated.

The first screw section 140 has a substantially cylindrical shape in which the size in the direction of rotation axis R is smaller than the size in the direction orthogonal to the direction of rotation axis R. The first screw section 140 is, for example, a flat screw. The first screw section 140 is connected to, for example, the drive motor 64. The first screw section 140 rotates about the rotation axis R by rotation of the drive motor 64. In the illustrated example, rotation axis R is parallel to the Y-axis.

The first screw section 140 has, for example, a shaft face 141 to which the shaft 66 of the drive motor 64 is connected, a facing surface 142 on the opposite side to the shaft face 141, and a connection surface 143 that connects the shaft face 141 and the facing surface 142. The facing surface 142 faces the facing surface 122 of the barrel 120. As illustrated in FIG. 6, the facing surface 142 is formed with first grooves 144 and an insertion hole 147. The connection surface 143 is, for example, perpendicular to the facing surface 142.

The first grooves 144 of the first screw section 140 include, for example, a material inlet section 145 and a material transfer section 146. The material inlet section 145 is formed on the outer periphery of the facing surface 142. That is, the material inlet section 145 is formed on the connection surface 143 of the first screw section 140. The material transfer section 146 is connected to the material inlet section 145. In the illustrated example, the material transfer section 146 is formed in a spiral shape from the insertion hole 147 toward the outer periphery of the facing surface 142. The material supplied from the material supply section 10 is supplied from the material inlet section 145 to the first grooves 144, passes through the material transfer section 146, and is transported to second grooves 154 formed in the second screw section 150. In the illustrated example, two first grooves 144 are formed. In the illustrated example, one of the first grooves 144 is indicated by a plurality of black dots, and the other first groove 144 is indicated by gray. This is the same for the second grooves 154.

It should be noted that the number of first grooves 144 is not particularly limited. Although not illustrated, three or more first grooves 144 may be formed, or only one first groove may be formed.

The first grooves 144 of the first screw section 140 has a portion where the width W1 is larger than the depth H1. In the illustrated example, the first grooves 144 have a width W1 greater than a depth H1 over the entire range.

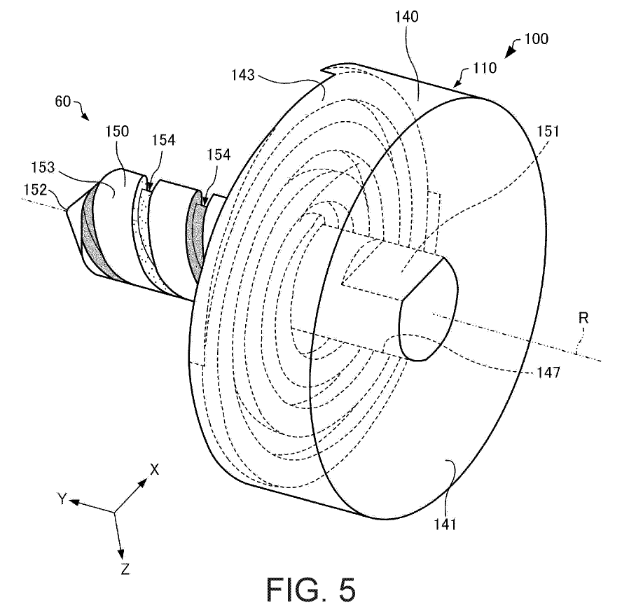

The insertion hole 147 of the first screw section 140 is formed at the center of the facing surface 142. In the example illustrated in FIG. 5, the insertion hole 147 penetrates the first screw section 140, but may not penetrate the first screw section 140. The second screw section 150 is inserted into the insertion hole 147. As illustrated in FIG. 6, a receiving section 148 for receiving the second screw section 150 is provided on the inner surface of the insertion hole 147. The receiving section 148 protrudes from the inner surface of the insertion hole 147 toward the center.

The second screw section 150 is connected to the first screw section 140. The second screw section 150 is inserted into the insertion hole 147 of the first screw section 140. As illustrated in FIG. 7, the second screw section 150 has a D-cut section 151. The D-cut section 151 is in contact with the receiving section 148 provided on the inner surface of the insertion hole 147. The first screw section 140 and the second screw section 150 are separate bodies. The second screw section 150 may be screwed to the first screw section 140. The material of the first screw section 140 and the material of the second screw section 150 are, for example, the same. The first screw section 140 and the second screw section 150 are made of, for example, metals such as SUS440C.

It should be note that the first screw section 140 and the second screw section 150 may be integrated. The first screw section 140 and the second screw section 150 may be separate bodies, and the material of the first screw section 140 and the material of the second screw section 150 may be different from each other. For example, the second screw section 150 close to the heating sections 130 may be formed of a material having a smaller coefficient of thermal expansion than that of the first screw section 140 far from the heating sections 130.

The second screw section 150 may be attachable to and detachable from the first screw section 140. Although not illustrated, the second screw section 150 may be removed from the first screw section 140, and a nest may be inserted into the insertion hole 147 to use the first screw section 140 as a flat screw.

The second screw section 150 rotates about the rotation axis R in accordance with rotation of the first screw section 140. The second screw section 150 performs the same rotational motion as the first screw section 140. That is, the number of rotations of the second screw section 150 is the same as the number of rotations of the first screw section 140, and the rotation direction of the second screw section 150 is the same as the rotation direction of the first screw section 140. In the example illustrated in FIG. 2, the second screw section 150 is connected to the shaft 66 of the drive motor 64. It should be noted that, although not illustrated, the insertion hole 147 may not penetrate the first screw section 140, and the second screw section 150 may be spaced apart from the shaft 66 of the drive motor 64.

As illustrated in FIG. 4, the second screw section 150 protrudes in the +Y-axis direction from the facing surface 142 of the first screw section 140. The second screw section 150 is located to overlap the rotation axis R. The rotation axis R passes through, for example, the center of the second screw section 150. The second screw section 150 overlaps, when viewed from the Y-axis direction, the center of the first screw section 140. When viewed from the Y-axis direction, the outer periphery of the second screw section 150 is located inside the outer periphery of the first screw section 140.

As illustrated in FIG. 2, at least a portion of the second screw section 150 is located in the communication hole 126 formed in the barrel 120. Half or more of the volume of the second screw section 150 is located in the communication hole 126. The tip end 152 of the second screw section 150 is located in the communication hole 126. The tip end 152 is located on the -Y-axis direction side of the cylinder 72. The tip end 152 is an end of the second screw section 150 in the +Y-axis direction. When viewed from the Y-axis direction, the shape of the tip end 152 is, for example, a circle. As illustrated in FIG. 4, in the Y-axis direction, a distance L between the tip end 152 and the facing surface 142 is larger than a width D of the second screw section 150. The distance L is the size of the portion of the second screw section 150 protruding from the facing surface 142 in the Y-axis direction. The width D is, when viewed from the Y-axis direction, for example, the diameter of the second screw section 150.

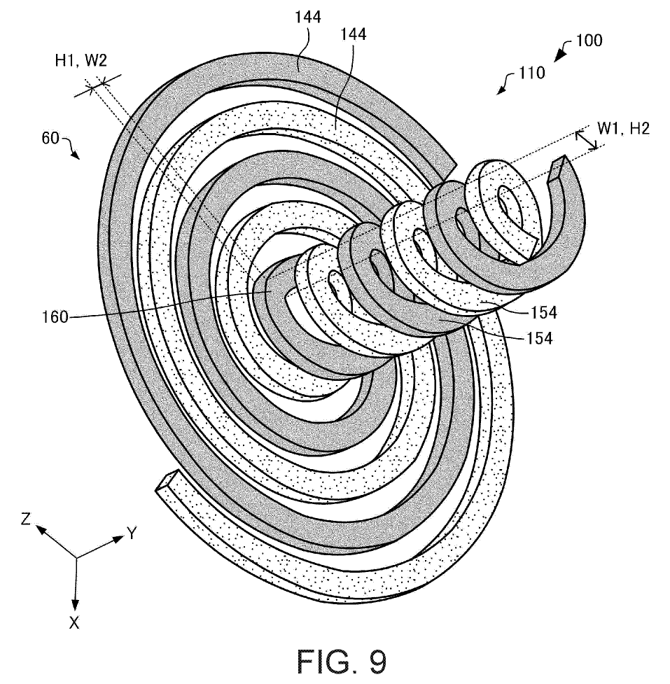

The second screw section 150 has a side surface 153. The side surface 153 is parallel to the Y-axis. The perpendicular line of the side surface 153 is orthogonal to the Y-axis. The side surface 153 is, for example, orthogonal to the facing surface 142. The side surface 153 has second grooves 154. The second grooves 154 are formed in a spiral shape. Here, FIG. 9 is a perspective view schematically illustrating the first grooves 144 and the second grooves 154.

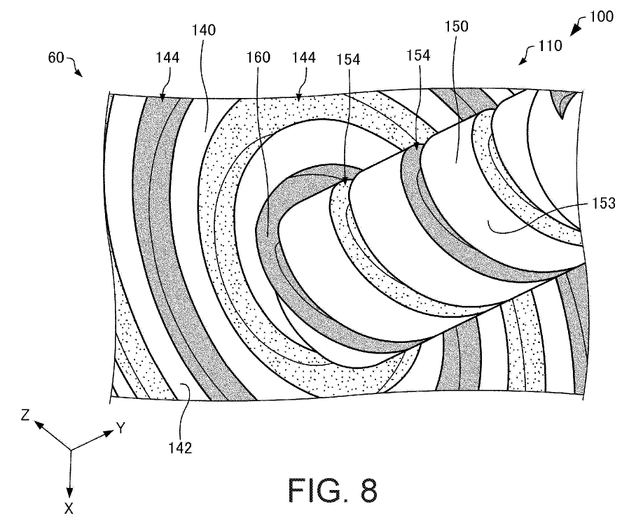

As illustrated in FIGS. 8 and 9, the second grooves 154 are connected to the first grooves 144. The second grooves 154 are continuous with the first grooves 144. The number of the second grooves 154 is the same as the number of the first grooves 144. In the illustrated example, two second grooves 154 are formed. As illustrated in FIG. 9, at the connecting section 160 between the first grooves 144 and the second grooves 154, the width W1 of the first grooves 144 and the depth H2 of the second grooves 154 are, for example, equal. In the connecting section 160, the depth H1 of the first grooves 144 and the width W2 of the second grooves 154 are, for example, equal. The width W1 is, for example, the size of the first grooves 144 in the radial direction of the first screw section 140, and is the size of the first grooves 144 in a direction orthogonal to the Y-axis direction. The depth H1 is the size of the first grooves 144 in the Y-axis direction. The width W2 is the size of the second grooves 154 in the Y-axis direction. The depth H2 is, for example, the size of the second grooves 154 in the radial direction of the second screw section 150, and is the size of the second grooves 154 in a direction orthogonal to the Y-axis direction. In the connecting section 160, the first grooves 144 and the second grooves 154 are, for example, smoothly connected to each other without forming a step.

### 1.4. Operational effects

The plasticizing device 60 includes the drive motor 64, the screw 110 rotated by the drive motor 64, the barrel 120 that is positioned to face the screw 110 and that has the communication hole 126 formed therein through which the plasticized material flows out to the outside, and the first heating section 130a that heats the material. The screw 110 includes a first screw section 140 that has a facing surface 142 opposing the barrel 120, and a second screw section 150 that protrudes from the facing surface 142 in the direction of the rotation axis R of the first screw section 140 and that has a tip end 152 located in the communication hole 126. The second screw section 150 is located to overlap the rotation axis R. First grooves 144 to which the material is supplied is formed on the facing surface 142 of the first screw section 140, and second grooves 154 connected to the first grooves 144 are formed on the side surface 153 of the second screw section 150. In the direction of the rotation axis R, a distance L between the tip end 152 of the second screw section 150 and the facing surface 142 of the first screw section 140 is larger than a width D of the second screw section 150.

Therefore, in the plasticizing device 60, the plasticizing amount of the material per unit time can be improved as compared with a case where the distance L is smaller than the width D. The second screw section 150 can reduce the possibility that the material stays in the screw 110.

For example, in the flat screw, the material is transported from the outer peripheral side toward the center portion, but in the flat screw, the speed at the outer periphery is the highest, and the speed at the center portion is the lowest and is estimated to be substantially zero. Due to this phenomenon, at the center portion of the flat screw, the flow of the material is less likely to occur, and the material remains there. Therefore, the amount of plasticization of the material per unit time is reduced.

In order to solve such a problem, the plasticizing device 60 includes the second screw section 150, and thus it is possible to reduce the possibility that the material is retained in the screw 110. In the plasticizing device 60, it is possible to achieve a reduction in size in the Y-axis direction as compared with a case where the screw is configured only by the in-line screw.

In the plasticizing device 60, at the connecting section 160 between the first grooves 144 and the second grooves 154, the width W1 of the first grooves 144 and the depth H2 of the second grooves 154 are equal to each other, and the depth H1 of the first grooves 144 and the width W2 of the second grooves 154 are equal to each other. Therefore, in the plasticizing device 60, the material can easily flow in the connecting section 160, and the possibility of the material staying there can be further reduced.

The plasticizing device 60 includes the second heating sections 130b that heat the material, and the first heating sections 130a and the second heating sections 130b are arranged in the direction of the rotation axis R. Therefore, in the plasticizing device 60, the heated region of the second screw section 150 can be increased, and the plasticizing amount of the material per unit time can be further improved.

In the plasticizing device 60, the first screw section 140 and the second screw section 150 are separate bodies, and the material of the first screw section 140 and the material of the second screw section 150 are the same. Therefore, in the plasticizing device 60, the coefficient of thermal expansion of the first screw section 140 and the coefficient of thermal expansion of the second screw section 150 can be made the same, and the possibility of a gap occurring between the first grooves 144 and the second grooves 154 can be reduced. This can reduce the possibility of the material leaking from between the first grooves 144 and the second grooves 154.

It should be note that the first screw section 140 and the second screw section 150 may be integrated. When the first screw section 140 and the second screw section 150 are integrated, it is possible to reduce the possibility that the material leaks from between the first grooves 144 and the second grooves 154.

The injection molding device 100 includes the plasticizing device 60, the nozzle 80 that discharges the material by the plasticizing device 60, and the mold section 30 that opens and closes the molding die 32, which has the cavity 34 to which the discharged material is supplied. Therefore, in the injection molding device 100, the amount of plasticization of the material per unit time can be improved.

### 2. Modifications of injection molding device

### 2.1. First modification

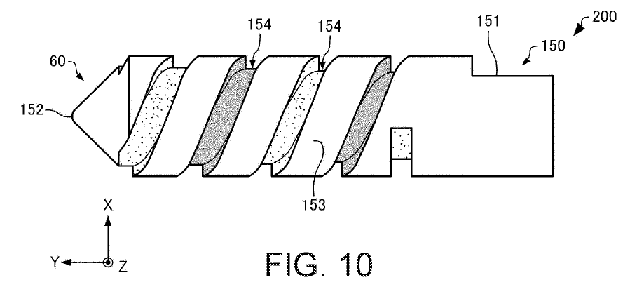

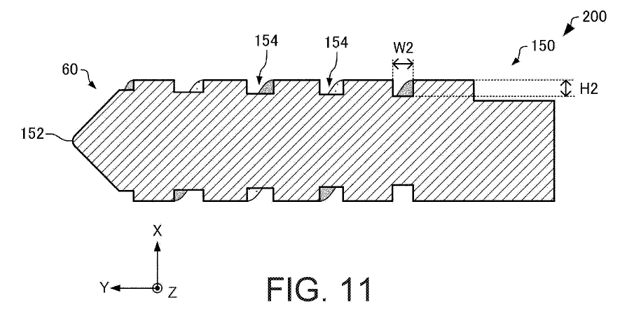

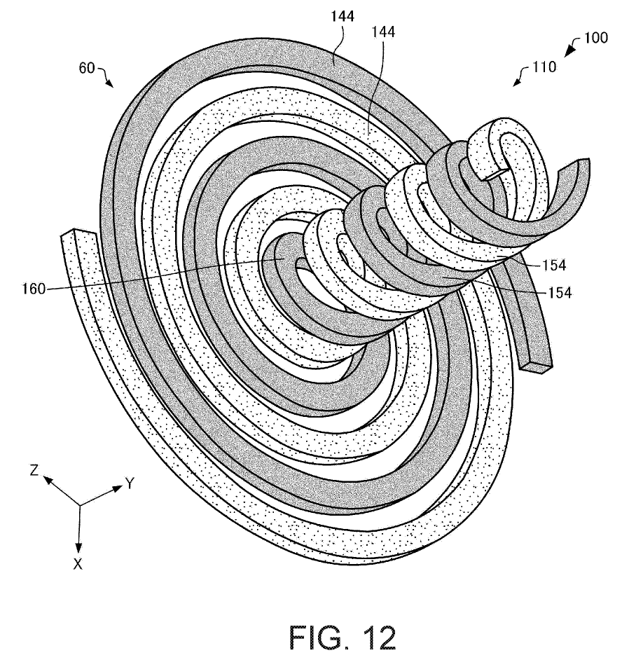

Next, an injection molding device according to a first modification of the present embodiment will be described with reference to the drawings. FIG. 10 is a side view schematically illustrating a second screw section 150 of an injection molding device 200 according to a first modification of the present embodiment. FIG. 11 is a cross-sectional view schematically illustrating a second screw section 150 of an injection molding device 200 according to a first modification of the present embodiment. FIG. 12 is a perspective view schematically illustrating first grooves 144 and second grooves 154 of the injection molding device 200 according to the first modification of the present embodiment.

Hereinafter, in the injection molding device 200 according to the modification of the present embodiment, points different from the example of the injection molding device 100 according to the present embodiment described above will be described, and the description of the same points will be omitted.

As illustrated in FIGS. 10 to 12, the injection molding device 200 is different from the injection molding device 100 described above in the shape of the second grooves 154 of the second screw section 150.

In the injection molding device 200, the width W2 of the second grooves 154 gradually increase from the connecting section 160 between the first grooves 144 and the second grooves 154 toward the tip end 152 of the second screw section 150. The width H2 of the second grooves 154 gradually decrease from the connecting section 160 toward the tip end 152. The second grooves 154 have a portion where the width W2 is greater than the depth H2.

In the plasticizing device 60 of the injection molding device 200, the first grooves 144 have a portion where the width W1 is larger than the depth H1, and the second grooves 154 have a portion where the width W2 is larger than the depth H2. Therefore, in the plasticizing device 60 of the injection molding device 200, the material can easily flow in the first grooves 144 and the second grooves 154, and the possibility of the material staying there can be further reduced.

### 2.2. Second modification

Next, an injection molding device according to a modification of the present embodiment will be described. Hereinafter, in the injection molding device according to the modification of the present embodiment, points different from the example of the injection molding device 100 according to the present embodiment described above will be described, and the description of the same points will be omitted.

In the injection molding device 100 described above, the material supplied from the material supply section 10 to the injection section 20 is an ABS resin.

In contrast, in the injection molding device according to the modification of the present embodiment, the material supplied from the material supply section 10 to the injection section 20 is a material other than an ABS resin or a material obtained by adding another component to an ABS resin.

Examples of the material supplied from the material supply section 10 include materials that contain various materials as a main material, such as a thermoplastic material, a metal material, and a ceramic material. Here, "main material" means the central material for molding the shape of the molded article formed by the injection molding device, and means a material that occupies a content rate of 50% or more in the molded article. The above-described materials include those obtained by melting the main materials alone, and those obtained by melting some components contained together with the main materials to form a paste.

As a material having thermoplastic material, for example, a thermoplastic resin can be used. Examples of thermoplastic resin include general purpose plastics, general purpose engineering plastics, and super engineering plastics.

Examples of the general purpose plastic include polypropylene (PP), polyethylene (PE), polyvinyl chloride (PVC), and polylactic acid (PLA).

Examples of general purpose engineering plastic include polyacetal (POM), polyamide (PA), polycarbonate (PC), modified polyphenylene ether (m-PPE), polybutylene terephthalate (PBT), and polyethylene terephthalate (PET).

Examples of super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

The thermoplastic material may contain a pigment, a metal, a ceramic, and additives such as a wax, a flame retardant, an antioxidant, and a heat stabilizer. The material that has thermoplasticity is plasticized and converted into a melting state by rotation of the screw 110 and the heating of the heating sections 130 in the plasticizing device 60. The plasticization material thus generated is discharged from the nozzle 80, deposited in the cavity 34, and then cured by a decrease in temperature.

In the plasticizing device 60, for example, a metal material may be used as the main material instead of the above-described material that has thermoplasticity. In this case, it is desirable that a component that melts when the plasticization material is generated is mixed with a powder material obtained by powdering the metal material, and the powder material is charged into the plasticizing device 60.

Examples of the metal material include a single metal such as magnesium (Mg), iron (Fe), cobalt (Co), chromium (Cr), aluminum (Al), titanium (Ti), copper (Cu), or nickel (Ni), an alloy that contains one or more of these metals, maraging steel, stainless steel, cobalt chromium molybdenum, a titanium alloy, a nickel alloy, an aluminum alloy, a cobalt alloy, and a cobalt chromium alloy.

In the plasticizing device 60, a ceramic material can be used as the main material instead of the above-described metal material. Examples of a ceramic material include oxide ceramics such as silicon dioxide, titanium dioxide, aluminum oxide, and zirconium oxide, and non-oxide ceramics such as aluminum nitride.

The powder material of the metal material or the ceramic material supplied from the material supply section 10 may be a mixed material obtained by mixing a plurality of types of powders of a single metal, a powder of an alloy, or a powder of a ceramic material. The powder material of the metal material or the ceramic material may be coated with, for example, the above-described thermoplastic resin or another thermoplastic resin. In this case, the thermoplastic resin may be melted in the plasticizing device 60 to exhibit fluidity.

For example, a solvent may be added to the powder material of the metal material or to the ceramic material supplied from the material supply section 10. Examples of the solvent include water; (poly) alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ - picoline, and 2, 6-lutidine; tetraalkylammonium acetates (for example, tetrabutylammonium acetate); and ionic liquids such as butyl carbitol acetate.

In addition, a binder may be added, for example, to the powder material of the metal material or the ceramic material supplied from the material supply section 10. Examples of the binder include an acrylic resin, an epoxy resin, a silicone resin, a cellulose-based resin, other synthetic resins, PLA, PA, PPS, PEEK, and other thermoplastic resins.

### 3. Three dimensional molding device

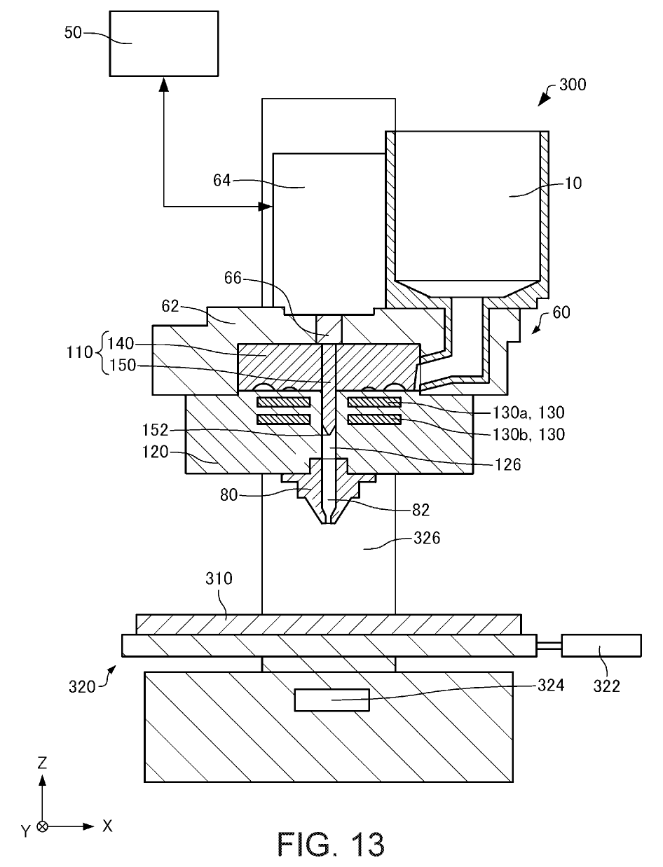

Next, a three dimensional molding device according to the present exemplary embodiment will be described with reference to the drawings. FIG. 13 is a cross-sectional view schematically illustrating a three dimensional molding device 300 according to the present embodiment. Hereinafter, in the three dimensional molding device 300 of the present embodiment, points different from the example of the injection molding device 100 according to the present embodiment described above will be described, and the description of the same points will be simplified or omitted.

As illustrated in FIG. 13, the three dimensional molding device 300 includes, for example, the material supply section 10, the control section 50, the plasticizing device 60, the nozzle 80, a stage 310, and a position changing section 320. The three dimensional molding device 300 is a three dimensional molding device of a Fused Deposition Modeling (FDM) method.

The nozzle 80 discharges the plasticized material supplied from the plasticizing device 60 toward the stage 310. Specifically, the three dimensional molding device 300, while ejection the plasticized material from the nozzle 80 to the stage 310, drives the position changing section 320 to change the relative position between the nozzle 80 and the stage 310. By this, the three dimensional molding device 300 shapes a three dimensional molding object having a desired shape on the stage 310.

The stage 310 is provided below the nozzle 80. In the illustrated example, the shape of the stage 310 is a rectangular parallelepiped. The stage 310 supports the plasticized material discharged from the nozzle 80. Plasticized material is deposited on the stage 310. The material of the stage 310 is, for example, a metal such as aluminum.

The position changing section 320 supports the stage 310. The position changing section 320 changes the relative position between the nozzle 80 and the stage 310. In the illustrated example, the position changing section 320 changes the relative position between the nozzle 80 and the stage 310 in the X-axis direction and the Y-axis direction by moving the stage 310 in the X-axis direction and the Y-axis direction. The position changing section 320 changes the relative position between the nozzle 80 and the stage 310 in the Z-axis direction by moving the nozzle 80 in the Z-axis direction.

The position changing section 320 includes, for example, a first electric actuator 322, a second electric actuator 324, and a third electric actuator 326. The first electric actuator 322 moves the stage 310 in the X-axis direction. The second electric actuator 324 moves the stage 310 in the Y-axis direction. The third electric actuator 326 moves the nozzle 80 in the Z-axis direction. The third electric actuator 326 supports, for example, the screw case 62 of the plasticizing device 60.

It should be noted that the configuration of the position changing section 320 is not particularly limited as long as the relative position between the nozzle 80 and the stage 310 can be changed. For example, the position changing section 320 may be configured to move the stage 310 in the Z-axis direction and move the nozzle 80 in the X-axis direction and the Y-axis direction, or may be configured to move the stage 310 or the nozzle 80 in the X-axis direction, the Y-axis direction, and the Z-axis direction.

The plasticizing device 60 according to the present embodiment is not limited to the injection molding device and the three dimensional molding device, and may be used in, for example, an extruder.

The above-described embodiment and modifications are merely examples, and the present disclosure is not limited thereto. For example, the embodiments and the modifications can be combined as appropriate.

The present disclosure includes configurations substantially the same as the configurations described in the embodiments, for example, configurations that have the same functions, methods, and results, or configurations that have the same objects and effects. The present disclosure also includes configurations in which non-essential parts of the configurations described in the embodiments are replaced. The present disclosure includes a configuration that achieves the same operational effects as the configuration described in the embodiment or a configuration that can achieve the same object. The present disclosure also includes configurations in which known techniques are added to the configurations described in the embodiments.

The following contents are derived from the above-described embodiment and modifications.

An aspect of a plasticizing device includes

a plasticizing device that includes

a drive motor;

a screw rotated by the drive motor;

a barrel positioned to face the screw and having a communication hole through which plasticized material flows out to the outside; and

a first heating section configured to heat material, wherein

the screw includes

a first screw section that has a facing surface which oppose the barrel and

a second screw section protruding from the facing surface in a direction of a rotation axis of the first screw section, a tip end of the second screw section being located in the communication hole,

the second screw section is located to overlap the rotation axis,

a first groove to which the material is supplied is formed in the facing surface of the first screw section,

a second groove connected to the first groove is formed on a side surface of the second screw section, and

the rotation axis direction, a distance between the tip end of the second screw section and the facing surface of the first screw section is larger than a width of the second screw section.

According to this plasticizing device, the amount of plasticization of the material per unit time can be improved.

One aspect of the plasticizing device may be such that

the first groove has a portion having a width larger than a depth, and

the second groove has a portion where a width is larger than a depth.

According to the plasticizing device, the material can easily flow in the first groove and the second groove.

One aspect of the plasticizing device may be such that

a connecting section between the first groove and the second groove,

a width of the first groove and a depth of the second groove are equal to each other, and

a depth of the first groove and a width of the second groove are equal to each other.

According to the plasticizing device, the material can be made to easily flow in the connecting section.

One aspect of the plasticizing device may be such that

a second heating section configured to heat the material, and

the first heating section and the second heating section are arranged in the rotation axis direction.

According to this plasticizing device, it is possible to increase the heated region of the second screw section.

One aspect of the plasticizing device may be such that

the first screw section and the second screw section are integrated.

According to this plasticizing device, it is possible to reduce the possibility that the material leaks from between the first groove and the second groove.

One aspect of the plasticizing device may be such that

the first screw section and the second screw section are separate bodies, and

the first screw section and the second screw section are made of the same material.

According to this plasticizing device, it is possible to reduce the possibility that the material leaks from between the first groove and the second groove.

An aspect of an injection molding device includes

an injection molding device that includes

an aspect of the plasticizing device;

a nozzle that injects the material plasticized by the plasticizing device; and

a mold opening and closing device that opens and closes a molding die having a cavity to which the injected material is supplied.

According to this injection molding device, the amount of plasticization of the material per unit time can be improved.

One aspect of the screw comprises:

a screw provided in plasticizing device having communication hole through which a plasticized material flows out to the outside, the screw including

a first screw section that has a facing surface opposing the barrel, and

a second screw section that protrudes from the facing surface in a direction of a rotation axis of the first screw section and that has a tip end located in the communication hole, wherein

second screw section is located to overlap the rotation axis,

a first groove to which the material is supplied is formed in the facing surface of the first screw section,

a second groove connected to the first groove is formed on a side surface of the second screw section, and

in the rotation axis direction, a distance between the tip end of the second screw section and the facing surface of the first screw section is larger than a width of the second screw section.

According to this screw, the amount of plasticization of the material per unit time can be improved.

What is claimed is:

1. A plasticizing device, comprising:
a drive motor;
a screw rotated by the drive motor;
a barrel positioned to face the screw and having a communication hole through which plasticized material flows out to the outside; and
a first heating section configured to heat material, wherein
the screw includes
a first screw section that has a facing surface which oppose the barrel and
a second screw section protruding from the facing surface in a direction of a rotation axis of the first screw section, a tip end of the second screw section being located in the communication hole,
the second screw section is located to overlap the rotation axis,
a first groove to which the material is supplied is formed in the facing surface of the first screw section,
a second groove connected to the first groove is formed on a side surface of the second screw section, and
in the rotation axis direction, a distance between the tip end of the second screw section and the facing surface of the first screw section is larger than a width of the second screw section.

2. The plasticizing device according to claim 1, wherein
the first groove has a portion having a width larger than a depth and
the second groove has a portion where a width is larger than a depth.

3. The plasticizing device according to claim 1, wherein
with respect to a connecting section between the first groove and the second groove,
a width of the first groove and a depth of the second groove are equal to each other, and
a depth of the first groove and a width of the second groove are equal to each other.

4. The plasticizing device according to claim 1, wherein
a second heating section configured to heat the material, and
the first heating section and the second heating section are arranged in the rotation axis direction.

5. The plasticizing device according to claim 1, wherein
the first screw section and the second screw section are integrated.

6. The plasticizing device according to claim 1, wherein
the first screw section and the second screw section are separate bodies, and
the first screw section and the second screw section are made of the same material.

7. An injection molding device, comprising:
the plasticizing device according to claim 1;
a nozzle that injects the material plasticized by the plasticizing device; and
a mold opening and closing device that opens and closes a molding die having a cavity to which the injected material is supplied.

8. A screw provided in a plasticizing device having a communication hole through which a plasticized material flows out to the outside, the screw comprising:
a first screw section that has a facing surface opposing the barrel and
a second screw section that protrudes from the facing surface in a direction of a rotation axis of the first screw section and that has a tip end located in the communication hole, wherein
the second screw section is located to overlap the rotation axis,
a first groove to which the material is supplied is formed in the facing surface of the first screw section,
a second groove connected to the first groove is formed on a side surface of the second screw section, and
in the rotation axis direction, a distance between the tip end of the second screw section and the facing surface of the first screw section is larger than a width of the second screw section.
